(19) United States
(12) Patent Application Publication
(10) Pub. No.: US 2003/0150949 A1
(43) Pub. Date: Aug. 14, 2003

(54) Recording tape cartridge

(75) Inventor: Fumihito Imai, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/365,469

(22) Filed: Feb. 13, 2003

(30) Foreign Application Priority Data
Feb. 14, 2002 (JP) 2002-36209

(51) Int. Cl. G11B 23/107

(52) U.S. Cl. 242/348

(57) ABSTRACT

A recording tape cartridge including: a case formed from an upper case and a lower case, and accommodating a single reel, on which a recording tape is wound; an opening formed in the case, for pulling-out of the recording tape; a closing member fixed to a distal end of the recording tape, and for being pulled-out by a pull-out mechanism of a drive device, and for being able to close the opening; a first supporting member for supporting the closing member from a direction of thickness of the case and disposed at an inner surface of one of the upper case and the lower case; and a second supporting member for supporting the closing member from a direction orthogonal to the direction of thickness of the case, and disposed at the one of the upper case and the lower case at which the first supporting member is disposed.

### BACKGROUND OF THE INVENTION

1. Field of the Invention

The present invention relates to a recording tape cartridge accommodating, within a case, a single reel on which is wound a recording tape, such as a magnetic tape or the like, which is used as a recording/playback medium of a computer or the like.

2. Description of the Related Art

Conventionally, magnetic tape cartridges have been known in which a magnetic tape, which is used as a data recording/playback medium of a computer or the like, is wound on a single reel, and the reel is accommodated in a case formed of a synthetic resin. A leader member, such as a leader block, a leader pin, or a leader tape, is provided at the distal end or free end of the magnetic tape. A pull-out mechanism provided at a drive device pulls the leader member out from the magnetic tape cartridge, and winds the magnetic tape fixed thereto around a take-up reel of the drive device.

A reel gear is formed in an annular form in the center of the bottom surface of the reel which emerges from an open hole formed in the bottom surface of the magnetic tape cartridge. Due to a driving gear, which is provided at a rotating shaft of the drive device, meshing with this reel gear, the reel is driven to rotate. By driving the reel of the magnetic tape cartridge and the take-up reel of the drive device synchronously, data can be recorded onto the magnetic tape, and data recorded on the magnetic tape can be played back.

In such a magnetic tape cartridge, as mentioned above, a leader member is provided at the distal end of the magnetic tape. For example, as shown in FIG. 5, a leader block 70 is held at a case 80 so as to close an opening 76. Namely, plate-spring-shaped spring members 78, which are urged downwardly and upwardly respectively, are provided integrally at the inner surfaces of an upper case 82 and a lower case 84. A substantially hemispherical engaging projection 78A is formed to project at the distal end of the surface of the spring member 78 opposing the leader block 70. Substantially semispherical concave portions 72, with which the engaging projections 78A engage, are formed at a top surface 70A and a bottom surface 70B of the leader block 70.

Accordingly, the leader block 70 is pushed from above and from below by the urging forces of the spring members 78, and the engaging projections 78A are inserted into the concave portions 72. In this way, the leader block 70 is held between the upper case 82 and the lower case 84, and closes the opening 76. The holding force of the case 80 with respect to the leader block 70 at this time (i.e., the urging forces of the spring members 78) are such that, even if shock due to the case 80 being dropped or the like is applied to the case 80, the leader block 70 does not easily come out from the case 80.

When the leader block 70 is closing the opening 76, a magnetic tape T is held in a state in which a certain amount of load is applied thereto in the direction of being taken-up on a reel (not shown) such that the magnetic tape T does not go slack within the case 80. Thus, when the leader block 70 is to be pulled-out from the case 80 by a pull-out member 60 of a drive device, even if the reel is driven to rotate, a slight load is applied to the pull-out member 60. Accordingly, the pull-out member 60 must have pull-out force to the extent that it can counteract this load without severing or stretching the magnetic tape T, and that it can also counteract the holding force of the case 80 (i.e., the urging forces of the spring members 78).

The pull-out member 60 of the drive device is anchored at and connected to a concave portion 74 which is substantially circular arc shaped as seen in plan view and which is provided at the distal end of the leader block 70. Due to the pull-out member 60 moving outwardly (i.e., in the direction of moving away from the opening 76), the leader block 70 is pulled-out from the opening 76. At this time, accompanying this pull-out operation, the spring members 78 must deflect upwardly and downwardly, and the engaging projections 78A must come out from the concave portions 72.

Namely, in order for the leader block 70 to be suitably held at the case 80 when the magnetic tape cartridge is not being used, and for the leader block 70 to be suitably pulled-out from the case 80 when the magnetic tape cartridge is to be used, the delicate balance between the pull-out force of the pull-out member 60 and the holding force of the case 80 must be adjusted. Conventionally, such fine adjustment was of course carried out by adjusting the elastic forces of the spring members 78 provided at the upper case 82 and the lower case 84.

However, there is the concern that, due to impact caused by the case 80 being dropped or the like, the upper case 82 and/or the lower case 84 may deform or the like. In such a case, dispersion may arise in the interval between the spring members 78, and there is the concern that the problem that the leader block 70 cannot be suitably held will arise. Namely, the leader block 70 is held by two independent parts which are the spring member 78 at the upper case 82 and the spring member 78 at the lower case 84. Thus, even if the loads applied at the time of holding and pulling-out the leader block 70 are adjusted (i.e., even if the balance between the holding force of the spring members 78 and the pull-out force of the pull-out member 60 is adjusted), such a balance may be disturbed due to the aforementioned deformation or the like. In this case, there is the concern that there will be problems such as it will be easy for the leader block 70 to come out from between the upper case 82 and the lower case 84, or it will be difficult for the leader block 70 to come out from therebetween.

### SUMMARY OF THE INVENTION

An object of the present invention is to provide a recording tape cartridge in which a leader block can be held at a single part, i.e., either one of an upper case and a lower case.

A recording tape cartridge according to a first aspect of the invention comprises: a case formed from an upper case and a lower case, and accommodating a single reel, on which a recording tape is wound; an opening formed in the case, for pulling-out of the recording tape; a closing member fixed to a distal end of the recording tape, and for being pulled-out by a pull-out mechanism of a drive device, and for being able to close the opening; a first supporting member for supporting the closing member from a direction of thickness of the case and disposed at an inner surface of one of the upper case and the lower case; and a second supporting member for supporting the closing member from a direction orthogonal to the direction of thickness of the case, and disposed at the one of the upper case and the lower case at which the first supporting member is disposed.

In accordance therewith, the leader block is held at either one of the upper case and the lower case. Thus, it suffices to carry out, at that either one of the upper case and the lower case, the adjustment of the loads applied at the time of holding and pulling-out the leader block. Accordingly, even if a dispersion in dimensions arises between the upper case and the lower case, such dispersion does not affect the adjustment of loads applied at the time of holding and pulling-out the leader block. Namely, problems caused by a dispersion in dimensions, which problems could arise if the leader block were held at both the upper case and the lower case, do not arise in any way. Therefore, the leader block can be suitably held at the case, and can be suitably pulled out from the case by the pull-out mechanism of the drive device.

A container according to a second aspect of the invention comprises: a case formed from an upper case and a lower case, and including an opening; and a plurality of supporting members provided at a plurality of places at an inner surface of one of the upper case and the lower case, and supporting a closing member which can be attached to and removed from the opening and which closes the opening in a state in which at least a portion of the closing member is accommodated within the opening.

A method of supporting a closing member according to a third aspect of the invention comprises the steps of: (a) accommodating the closing member at an opening of a case, which includes the opening; and

(b) supporting the accommodated closing member with a plurality of supporting members.

### BRIEF DESCRIPTION OF THE DRAWINGS

FIG. 1 is an exploded perspective view of a recording tape cartridge relating to an embodiment of the present invention.

FIG. 2 is a front view showing a state in which a leader block relating to the embodiment of the present invention is closing an opening.

FIG. 3 is a perspective view showing a state in which the leader block relating to the embodiment of the present invention is closing the opening.

FIG. 4 is a perspective view showing a state in which a pull-out mechanism of a drive device is pulling-out the leader block relating to the embodiment of the present invention.

FIG. 5 is a perspective view showing a state in which a conventional leader block is closing an opening.

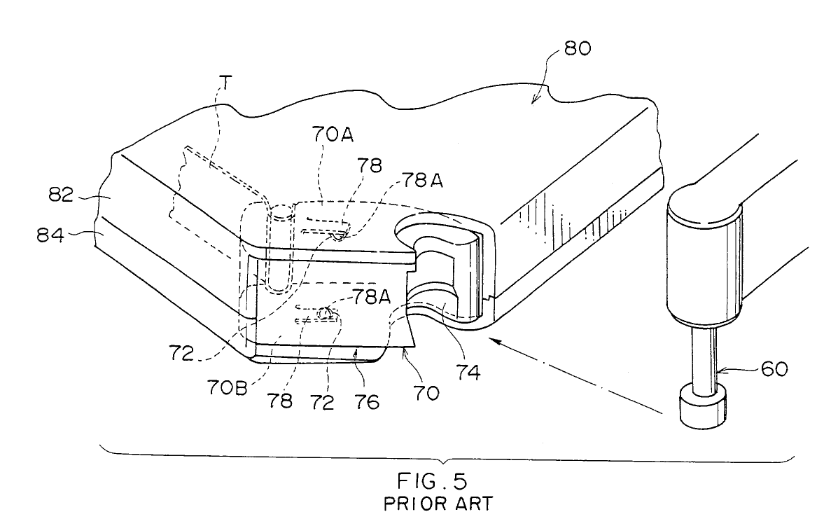

### DESCRIPTION OF THE PREFERRED EMBODIMENT

Hereinafter, an embodiment of the present invention will be described with reference to the drawings. Note that, for convenience of explanation, the direction of loading a recording tape cartridge into a drive device (the direction of arrow P) is the front direction, and the respective directions of front, rear, left, right, top and bottom are defined on the basis of this front direction. Further, a magnetic tape is employed as the recording tape, and hereinafter, a magnetic tape cartridge will be described.

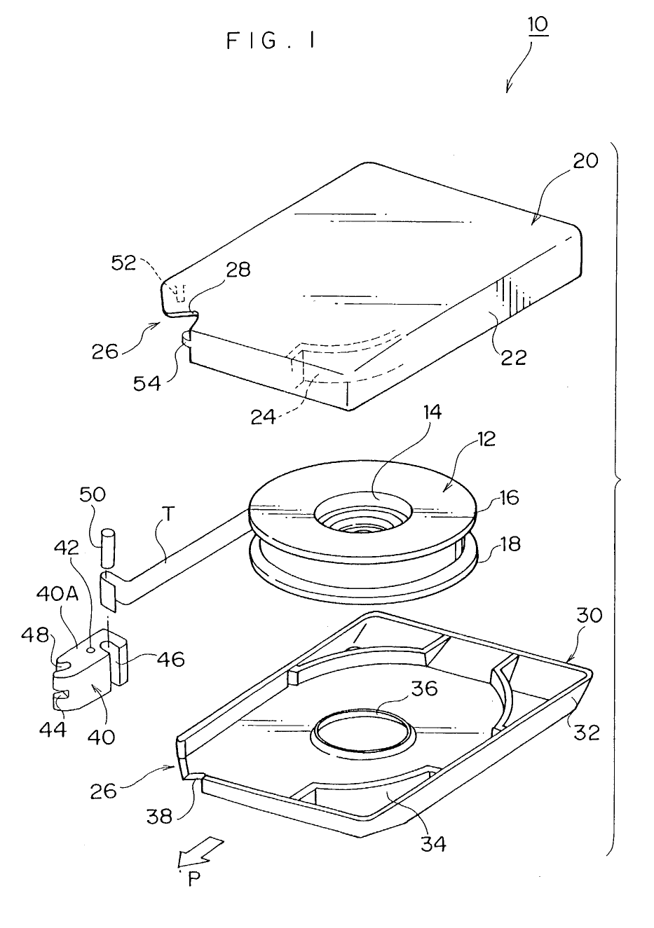

As shown in FIG. 1, a magnetic tape cartridge 10 is formed in a substantially rectangular shape by an upper case 20 and a lower case 30, which are formed of a synthetic resin, being joined together by peripheral walls 22, 32 thereof being ultrasonically welded or the like. A single reel 12, on which is wound a magnetic tape T serving as an information recording/playback medium, is rotatably accommodated at the interior of the magnetic tape cartridge 10. Play regulating walls 24, 34, which are formed in substantially circular arc shapes, stand erect at the inner surface of the upper case 20 and the inner surface of the lower case 30, respectively. The reel 12 is accommodated at the interior of the play regulating walls 24, 34.

A circular hole 36 is formed in the center of the lower case 30. A reel gear (not shown), which is formed in an annular form in the bottom surface of the reel 12, emerges out from this hole 36. At the reel 12, a hollow-cylindrical reel hub 14 and a lower flange portion 18, which extends in the radial direction from the outer periphery of the lower end of the reel hub 14, are molded integrally from a synthetic resin. An upper flange portion 16 of the same configuration as the lower flange portion 18 is joined by ultrasonic welding or the like to the top end of the reel hub 14. The magnetic tape T is wound on the outer peripheral surface of the reel hub 14.

Portions of the peripheral walls 22, 32 at the front right corner portion of the magnetic tape cartridge 10 are cut-out so as to form an opening 26. The opening 26 is for pulling-out, to the exterior, the magnetic tape T which is wound on the reel 12. When the magnetic tape cartridge 10 is not being used, a leader block (closing member) 40, which is attached to the distal end portion of the magnetic tape T, is anchored and held at this corner portion so as to close the opening 26.

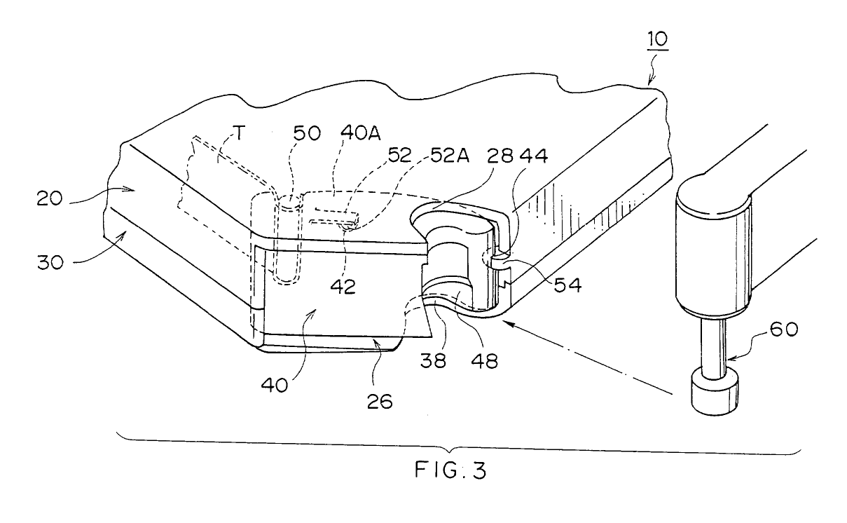

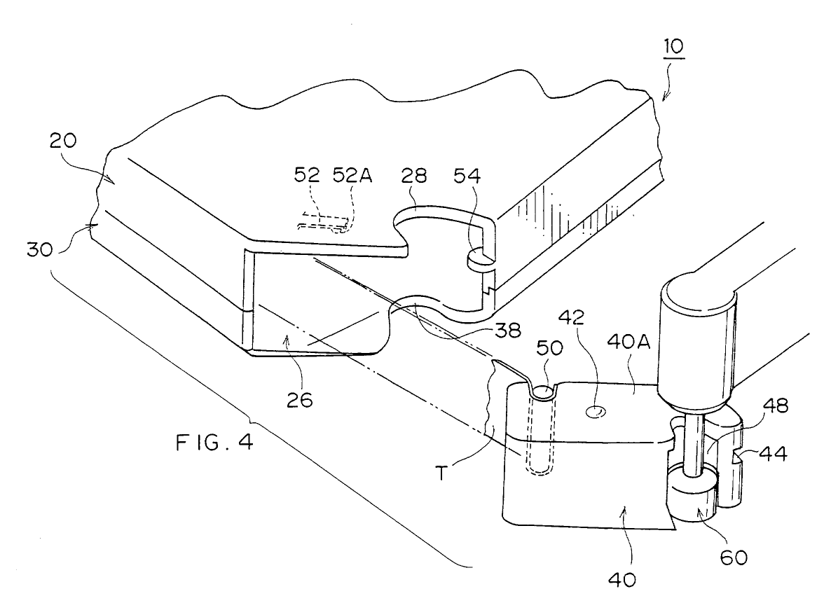

A concave portion 48 is formed in a substantially semicircular arc shape as seen in plan view, at the distal end portion of the leader block 40. Concave portions 28, 38, which, in plan view, have substantially the same circular arc shapes as the concave portion 48, are formed at the upper case 20 and the lower case 30 in a vicinity of the opening 26. The concave portions 28, 38 are formed at positions corresponding to the position of the concave portion 48 of the leader block 40 when the leader block 40 is closing the opening 26. Further, a pull-out member 60 (see FIGS. 3 and 4) of a drive device which pulls-out the leader block 40, can be easily inserted into the concave portion 48.

The pull-out member 60 is inserted into and connected with the concave portion 48, and moves the leader block 40 to a take-up reel (not illustrated) of the drive device. The leader block 40 is pulled-out from the magnetic tape cartridge 10, and is fit into a fit-in portion (not shown) provided at a reel hub of the take-up reel. In this way, the magnetic tape T can be wound onto the take-up reel of the drive device.

Next, the leader block 40, and supporting members of the case which anchor and hold the leader block 40 (in the present embodiment, the supporting members are provided at the upper case 20) will be described. As shown in FIGS. 1 through 4, the leader block 40 is formed in a substantially rectangular block shape formed of a synthetic resin or metal. The rear surface of the leader block 40 (the surface which is facing the reel 12 in FIG. 1) is formed in a substantially circular arc shape as seen in plan view such that, when the leader block 40 is fit into the fit-in portion of the take-up reel, the leader block 40 forms a portion of the outer peripheral surface of the reel hub. As described above, the concave portion 48, which is substantially circular arc shaped as seen in plan view and with which the pull-out member 60 of the drive device engages, is formed at the outer wall side of the distal end portion of the leader block 40 (the wall surface side which faces outwardly when the leader block 40 is closing the opening 26).

Further, a concave portion 46, which is substantially circular arc shaped in plan view and which is for attachment of the magnetic tape T, is formed at the inner wall of the leader block 40 (the wall facing the inner side when the leader block 40 is closing the opening 26). A substantially solid-cylindrical pin 50, which is formed of an elastic material and is formed to have the same diameter as or a diameter slightly larger than the diameter of the concave portion 46, is fit with the concave portion 46 such that the distal end or the free end of the magnetic tape T is nipped therebetween. In this way, the leader block 40 is attached to the distal end of the magnetic tape T.

A substantially semispherical concave portion 42 is formed in a top surface 40A of the leader block 40, which top surface 40A opposes the inner surface of the upper case 20. An engaging projection 52A of a spring member 52, which is a first supporting member provided or a thickness direction supporting member at the inner surface of the upper case 20, fits together with the concave portion 42. A cut-out portion 44 is formed at the distal end portion of the leader block 40. A rib 54, which is a second supporting member or an intersecting direction supporting member and which projects from the right end portion of the front wall of the upper case 20, engages with the cut-out portion 44. It is preferable to provide the concave portion 42 because the concave portion 42 can be used for positioning of the leader block 40 with respect to the upper case 20. However, it is also possible to not provide the concave portion 42.

The spring member 52, which is shaped as a plate spring, is provided integrally with the inner surface of the upper case 20. Due to the spring member 52 pushing the leader block 40 downwardly at a predetermined pressure, the leader block 40 is supported or fixed from the heightwise direction or thickness direction of the case. The substantially hemispherical engaging projection 52A is formed to project at the distal end of the surface of the spring member 52 which surface opposes the top surface 40A of the leader block 40. Note that the spring member 52 may be structured so as to be mounted to the inner surface of the upper case 20 by an arbitrary fixing means. In this case, the spring member 52 may be formed of metal.

Movement of the leader block 40 toward the rear is regulated by the rib 54, which is provided integrally with the right end portion of the front wall of the upper case 20 so as to project out, being inserted into and engaging with the cut-out portion 44 of the leader block 40. Namely, the rib 54 is a stopper which restricts the leader block 40 from inadvertently moving rearward (i.e., entering into the interior of the case).

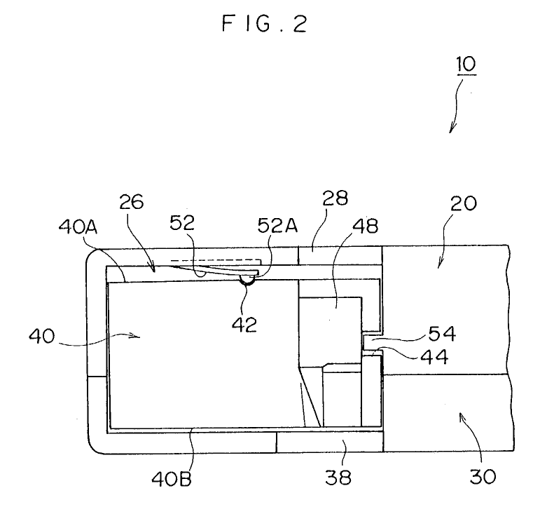

The configuration of the rib 54 is not limited to the configuration illustrated in FIGS. 1 through 4. However, as shown in FIG. 2, the thickness of the rib 54 is formed to be slightly thinner than the thickness of the cut-out portion 44 so that it is easy for the rib 54 to be inserted into the cut-out portion 44. Due to the leader block 40 being pressed downward by the spring member 52, the top surface of the rib 54 press-contacts the top surface of the cut-out portion 44. Chattering of the leader block 40 in the horizontal direction (i.e., the direction orthogonal to the direction of thickness and the direction of loading of the magnetic tape cartridge) is thereby further prevented, and in addition, the leader block 40 is thereby positioned with respect to the upper case 20.

In this way, the leader block 40 is structured to be held by the rib 54 and the spring member 52 which are provided only at the upper case 20. Therefore, there is no need to consider dispersion of dimensions (e.g., the interval) arising when the leader block 40 is held between two parts which are the upper case 20 and the lower case 30 as in the conventional art. Accordingly, the problem of imbalance in the loads applied at the time of holding and pulling-out the leader block 40 does not occur. The leader block 40 is suitably held at the case, and is suitably pulled-out from the case by the pull-out member 60.

Next, the processes of attaching and removing the leader block 40 to and from the upper case 20 will be described. As shown in FIG. 3, the pull-out member 60 of the drive device is made to engage with the concave portion 48 of the leader block 40, which is held at the upper case 20 by the spring member 52 and the rib 54 and which is closing the opening 26. Next, as shown in FIG. 4, in a state in which the pull-out member 60 is engaged with the concave portion 48, the pull-out member 60 is moved outwardly, in the direction of moving away from the opening 26.

At this time, the top surface 40A of the leader block 40 slides while being pressed by the spring member 52. However, the concave portion 42 is formed in a substantially semispherical shape, and the engaging projection 52A which engages therewith is formed in a substantially hemispherical shape. Thus, accompanying the pulling-out of the leader block 40, the engaging projection 52A smoothly comes out from the concave portion 42, and the problem of the top surface 40A of the leader block 40 being scratched due to this sliding does not occur. Further, because the rib 54 is merely inserted in the cut-out portion 44, the rib 54 does not impede movement of the leader block 40.

In this way, by removing the leader block 40 from the case, the opening 26 is opened, and the leader block 40 is wound on the take-up reel of the drive device. Then, by driving the reel 12 and the take-up reel to rotate synchronously, information can be recorded onto the magnetic tape T, or information recorded on the magnetic tape T can be played back.

When the recording and/or playback of the magnetic tape T is carried out, and the magnetic tape T is rewound onto the reel 12, and the leader block 40 is removed from the take-up reel, the opening 26 is once again closed by the leader block 40. Namely, the leader block 40 is inserted into the opening 26 by the pull-out member 60 which is engaged with the concave portion 48. At this time, the spring member 52 is deflected upwardly by the top surface 40A of the leader block 40 via the engaging projection 52A. Thereafter, due to the restoring force or urging force of the spring member 52, the engaging projection 52A is inserted into the concave portion 42A formed in the top surface 40A of the leader block 40. The rib 54 is inserted into the cut-out portion 44 at substantially the same time as the engaging projection 52A is inserted into the concave portion 42.

In this way, due to the urging force of the spring member 52, the leader block 40 is pressed downward at a predetermined pressure, and the position of the leader block 40 in the thickness direction is thereby regulated. Further, at the same time, the horizontal direction position of the leader block 40 is regulated by the rib 54 which engages with the cut-out portion 44, and the leader block 40 is held or supported at the upper case 20. The opening 26 is thereby closed. After the leader block 40 is held at the upper case 20, the pull-out member 60 separates from the concave portion 48.

As described above, the present invention is structured such that the leader block 40 is anchored and held only at the upper case 20. Therefore, even if there is dispersion in the dimensions of the upper case 20 and lower case 30, such dispersion does not affect the anchoring and holding of the leader block 40. Namely, in the conventional case in which the leader block 40 is held by two parts which are the upper case 20 and the lower case 30, when deformation or the like arises at the upper case 20 and/or the lower case 30, an error in the interval dimension between the upper case 20 and the lower case 30 arises, and the balance of loads of the holding force and the pull-out force may be disturbed. However, in the present invention, the leader block 40 is held by one part which is only one case, i.e., either the upper case 20 or the lower case 30. Therefore, the balance of the loads is not disturbed.

Accordingly, the problem of it being easy for the leader block 40 to come out from the case when the magnetic tape cartridge 10 is not being used, and the problem of it being difficult for the leader block 40 to come out from the case when the magnetic tape cartridge 10 is to be used, do not arise. Note that, in the present embodiment, a case in which the leader block 40 is held at the upper case 20 is described as an example. However, it goes without saying that the same effects can be achieved even if the leader block 40 is held at the lower case 30. Namely, the concave portion 42 may be provided in a bottom surface 40B of the leader block 40 which opposes the inner surface of the lower case 30, and the spring member 52 may be provided at the inner surface of the lower case 30, and the rib 54 may be provided to project from the right end portion of the front wall of the lower case 30, such that the leader block 40 is held only at the lower case 30.

In the present embodiment, the recording tape cartridge is described as an example. However, it goes without saying that the present invention can be applied not only to recording tape cartridges, but also to other containers.

As described above, in the present invention, a leader block can be held at either one of an upper case and a lower case. Therefore, problems caused by a dispersion in dimensions, which problems could arise if the leader block were held at both the upper case and the lower case, do not arise.

What is claimed is:

1. A recording tape cartridge comprising:
a case formed from an upper case and a lower case, and accommodating a single reel, on which a recording tape is wound;
an opening formed in the case, for pulling-out of the recording tape;
a closing member fixed to a distal end of the recording tape, and for being pulled-out by a pull-out mechanism of a drive device, and for being able to close the opening;
a first supporting member for supporting the closing member from a direction of thickness of the case and disposed at an inner surface of one of the upper case and the lower case; and
a second supporting member for supporting the closing member from a direction orthogonal to the direction of thickness of the case, and disposed at the one of the upper case and the lower case at which the first supporting member is disposed.

2. The recording tape cartridge of claim 1, wherein the first supporting member is formed from a spring member.

3. The recording tape cartridge of claim 1, wherein the second supporting member is formed integrally with the case.

4. The recording tape cartridge of claim 1, wherein the closing member has an engaging portion, and the closing member is moved from the opening by the pull-out mechanism engaging with the engaging portion.

5. The recording tape cartridge of claim 4, wherein the engaging portion is formed in a concave shape.

6. A container comprising:
a case formed from an upper case and a lower case, and including an opening; and
a plurality of supporting members provided at a plurality of places at an inner surface of one of the upper case and the lower case, and supporting a closing member which can be attached to and removed from the opening and which closes the opening in a state in which at least a portion of the closing member is accommodated within the opening.

7. The container of claim 6, wherein the plurality of supporting members include a thickness direction supporting member which supports the closing member from a direction of thickness of the case.

8. The container of claim 7, wherein the thickness direction supporting member is formed from a spring member.

9. The container of claim 7, wherein the thickness direction supporting member is formed integrally with the case.

10. The container of claim 7, wherein the plurality of supporting members include an intersecting direction supporting member which supports the closing member from a direction intersecting the direction of thickness of the case.

11. The container of claim 10, wherein the intersecting direction supporting member is formed integrally with the case.

12. The container of claim 10, wherein the container is a recording tape cartridge which accommodates, within the case, a reel which holds one end of a recording tape and on which the recording tape is wound, wherein recording and playback of information are carried out by the recording tape cartridge being loaded into a drive device, which includes a mechanism for pulling-out the recording tape.

13. The closing member utilized in the cartridge of claim 6, wherein the closing member includes a plurality of engaging portions which engage with the plurality of supporting members.

14. The container of claim 6, further comprising the closing member of claim 13.

15. A method of supporting a closing member, comprising the steps of:
(a) accommodating the closing member at an opening of a case, which includes the opening; and
(b) supporting the accommodated closing member with a plurality of supporting members.

16. The method of claim 15, wherein at least one supporting member of the plurality of supporting members supports the closing member from a direction of thickness of the case.

17. The method of claim 15, wherein at least one supporting member of the plurality of supporting members supports the closing member from a direction intersecting a direction of thickness of the case.

18. The method of claim 17, wherein the intersecting direction is a direction orthogonal to the direction of thickness of the case.
